(19) United States
(12) Patent Application Publication
(10) Pub. No.: US 2026/0066361 A1
(43) Pub. Date: Mar. 5, 2026

(54) SECONDARY BATTERY

(71) Applicant: Samsung SDI Co., Ltd., Yongin-si (KR)

(72) Inventors: Dae Kyu KIM, Yongin-si (KR); Chang Wook KIM, Yongin-si (KR); Sang Hyun KIM, Yongin-si (KR); Jong Jun PARK, Yongin-si (KR); Kwang Soo SEO, Yongin-si (KR); Jeong Chull AHN, Yongin-si (KR); Jae Woong WI, Yongin-si (KR); Tae Yoon LEE, Yongin-si (KR)

(21) Appl. No.: 19/384,525

(22) Filed: Nov. 10, 2025

Related U.S. Application Data
(63) Continuation of application No. 17/817,259, filed on Aug. 3, 2022.

(30) Foreign Application Priority Data
Aug. 6, 2021 (KR) 10-2021-0103894

(51) Int. Cl. H01M 10/0587

(52) U.S. Cl. CPC H01M 10/0587

(57) ABSTRACT

A secondary battery, includes an electrode assembly including a first electrode plate, a second electrode plate, and a separator wherein the electrode assembly is wound; a can for accommodating the electrode assembly and an electrolyte; a finishing tape including a film layer comprising a nylon material and an adhesive layer for attaching the film layer to the electrode assembly, wherein the finishing tape at least partially surrounds the electrode assembly; and a cap assembly that seals the can.

### CROSS-REFERENCE TO RELATED APPLICATION

This application is a continuation of U.S. patent application Ser. No. 17/817,259 filed on Aug. 3, 2022, and claims priority to and the benefit of Korean Patent Application No. 10-2021-0103894 filed on Aug. 6, 2021 in the Korean Intellectual Property Office, the entire content of each of which is incorporated by reference herein.

### BACKGROUND

### 1. Field

Aspects of embodiments of the present disclosure relate to a secondary battery.

### 2. Description of the Related Art

Unlike a primary battery that cannot be recharged, a secondary battery is a battery that can be repeatedly discharged and recharged. A low-capacity secondary battery comprised of one single cell packaged in the form of a pack may be used for various portable small-sized electronic devices, such as cellular phones and/or camcorders, and a high-capacity secondary battery in which several tens of cells are connected in a battery pack is widely used as a power source for motor drives, such as those in hybrid vehicles and/or electric vehicles.

The secondary battery may include an electrode assembly including a negative electrode and a positive electrode, a can for accommodating the same, terminals connected to the electrode assembly, and/or the like. Secondary batteries can be classified into circular, prismatic, and pouch types (kinds) according to the shapes thereof.

The above information disclosed in this Background section is only for enhancement of understanding of the background of the present disclosure and therefore it may contain information that does not constitute prior art.

### SUMMARY

Aspects of one or more embodiments of the present disclosure are directed toward a secondary battery capable of preventing or substantially preventing an electrode assembly from being damaged.

Aspects of one or more embodiments of the present disclosure are directed toward a secondary battery capable of improving the battery capacity.

Additional aspects will be set forth in part in the description which follows and, in part, will be apparent from the description, or may be learned by practice of the presented embodiments of the disclosure.

A secondary battery according to one or more embodiments of the present disclosure may include: an electrode assembly including a first electrode plate, a second electrode plate, and a separator where the electrode assembly is wound; a can for accommodating the electrode assembly and an electrolyte; a finishing tape including a film layer including (e.g., made or composed of) a nylon material and an adhesive layer for attaching the film layer to the electrode assembly, wherein the finishing tape at least partially surrounds (or is around) the electrode assembly; and a cap assembly that seals the can.

In one or more embodiments, the film layer may chemically react with the electrolyte to be at least partially melted and/or to form pores.

In one or more embodiments, the film layer may have a thickness of 12 μm to 25 μm.

In one or more embodiments, the adhesive layer may include an acrylic component.

In one or more embodiments, the adhesive layer may have a thickness of 3 μm or less. Here, as long as the adhesive layer can properly and stably attach the film layer to the electrode assembly, the thinner the adhesive layer, the more enhanced or advantageous it is, and thus the lower limit thereof is not specifically specified.

However, without limiting the scope of the present disclosure, and purely for convenience of understanding, the adhesive layer may be formed to a thickness of, for example, 1 μm to 3 μm.

### BRIEF DESCRIPTION OF DRAWINGS

FIG. 1 is a schematic, exploded perspective diagram showing a secondary battery according to one or more embodiments of the present disclosure.

FIG. 2 is schematic diagram of a finishing tape according to one or more embodiments of the present disclosure.

FIG. 3 is a schematic image showing an electrolyte applied to three finishing tapes and a glass plate placed thereon, according to one or more embodiments of the present disclosure.

FIG. 4 is a schematic image showing the glass plate applied to the finishing tapes of FIG. 3 and left undisturbed at room temperature for one day, according to one or more embodiments of the present disclosure.

FIG. 5 is a schematic image showing the finishing tapes of FIG. 4 in which the glass plate is pushed upward, according to one or more embodiments of the present disclosure.

FIG. 6-8 are each a schematic image of the finishing tapes attached to electrode assemblies and observed after a certain period of time has elapsed, according to one or more embodiments of the present disclosure.

FIG. 9-11 are perspective views showing one or more suitable configurations in which a finishing tape may be applied to a secondary battery, according to one or more embodiments of the present disclosure.

### DETAILED DESCRIPTION

Hereinafter, one or more embodiments of the present disclosure will be described in detail with reference to the accompanying drawings.

Examples of the present disclosure are provided to more completely explain the present disclosure to those skilled in the art, and the following examples may be modified in one or more suitable other forms. The present disclosure, however, may be embodied in many different forms and should not be construed as being limited to the example embodiments set forth herein. Rather, these example embodiments are provided so that this disclosure will be thorough and complete and will convey the aspects and features of the present disclosure to those skilled in the art. Accordingly, processes, elements, and techniques that are not necessary to those having ordinary skill in the art for a complete understanding of the aspects and features of the present disclosure may not be described.

In addition, in the accompanying drawings, sizes or thicknesses of various components are exaggerated for brevity and clarity. Like numbers refer to like elements throughout, and duplicative descriptions thereof may not be provided. As used herein, the term “and/or” includes any and all combinations of one or more of the associated listed items. In addition, it will be understood that when an element A is referred to as being “connected to” or “on” an element B, the element A can be directly connected to or on the element B or one or more intervening elements C may be present therebetween such that the element A and the element B are indirectly connected to each other. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms that the terms “comprise” or “include”and/or “comprising” or “including,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and/or the like, may be used herein for ease of explanation to describe one element or feature's relationship to another element(s) or feature(s) as illustrated in the drawings. It will be understood that the spatially relative terms are intended to encompass different orientations of the device in use or operation in addition to the orientation depicted in the drawings. For example, if the element or feature in the drawings is turned over, elements described as “below” or “beneath” other elements or features would then be oriented “on” or “above” the other elements or features. Thus, the example term “below”can encompass both an orientation of above and below.

As used herein, the term “substantially,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value. Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,”respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

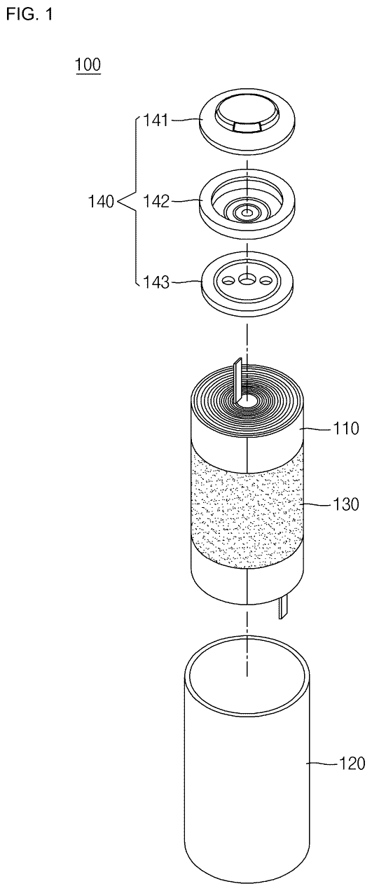

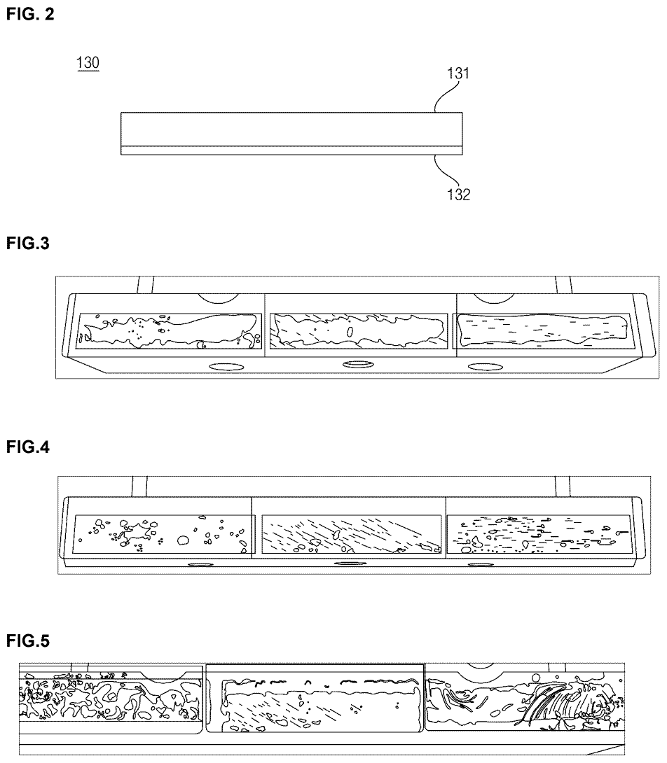

FIG. 1 is a schematic, exploded perspective diagram showing a secondary battery 100 according to one or more embodiments of the present disclosure and FIG. 2 is a schematic diagram of a finishing tape 130 according to one or more embodiments of the present disclosure.

Referring to FIG. 1, the secondary battery 100 includes an electrode assembly 110, a can 120, a finishing tape 130, and a cap assembly 140.

The electrode assembly 110 includes a first electrode plate, a second electrode plate, and a separator (to, e.g., separate and/or insulate the first electrode plate from the second electrode plate or vice versa). The first electrode plate may be either a negative electrode plate or a positive electrode plate. When the first electrode plate is a negative electrode plate, the first electrode plate may include, for example, but not limited to, a negative electrode coating portion coated with a negative electrode active material on a negative electrode current collector plate made of a thin conductive metal plate, for example, copper and/or nickel foil and/or mesh, and a negative electrode uncoated portion on which the negative electrode active material is not coated. Here, the negative active material may include, for example, but not limited to, a carbon-based material, Si, Sn, tin oxide, a tin alloy composite, a transition metal oxide, lithium metal nitrite, and/or a metal oxide. The second electrode plate may be either a negative electrode plate or a positive electrode plate. When the first electrode plate is a negative electrode plate, the second electrode plate may be a positive electrode plate. In this case, the second electrode plate may include, for example, but not limited to, a positive electrode coating portion coated with a positive electrode active material on a positive electrode current collector plate made of a thin metal plate having excellent or suitable conductivity, for example, aluminum foil and/or mesh, and a positive electrode uncoated portion on which the positive electrode active material is not coated. Here, the positive active material may include, for example, but not limited to, a chalcogenide compound, for example, a composite metal oxide, such as LiCoO₂, LiMn₂O₄, LiNiO₂, and/or LiNiMnO₂. In one or more embodiments, the separator is interposed between the first electrode plate and the second electrode plate to prevent (or protect from) an electrical short (or reduce the number of electrical shorts) between the first electrode plate and the second electrode plate. The separator may be made of, for example, but not limited to, polyethylene, polypropylene, a porous copolymer of polyethylene and polypropylene, and/or the other suitable material(s). In one or more embodiments, in order to effectively prevent (or protect from) an electric short (or reduce the number of electrical shorts) between the first electrode plate and the second electrode plate, the separator may be formed to be larger than the first electrode plate and the second electrode plate. The electrode assembly 110 is also wound in the form of a so-called “jelly-roll.”

The can 120 is formed in a cylindrical shape with one open surface. The can 120 accommodates the electrode assembly 110, an electrolyte, and/or other suitable material(s), and may be electrically connected to the first electrode plate of the electrode assembly 110 through the bottom.

The electrolyte may include, for example, but not limited to, an organic solvent, such as ethylene carbonate (EC), propylene carbonate (PC), diethyl carbonate (DEC), dimethyl carbonate (DMC), and/or ethyl methyl carbonate (EMC), and a lithium salt, such as LiPF₆, and/or LiBF₄.

The finishing tape 130 is for fixing the electrode assembly 110 so that the electrode assembly 110 is not unwound in the process of inserting the electrode assembly 110 into the can 120 in assembling the secondary battery 100, and at least partially surrounds (or is around) the electrode assembly 110. The finishing tape 130 includes a film layer 131 constituting an outer surface and an adhesive layer 132 for attaching the film layer 131 to the electrode assembly 110 (see, e.g., FIG. 2). In the secondary battery 100 according to one or more embodiments of the present disclosure, the film layer 131 may be formed of a nylon material, and the adhesive layer 132 may be formed of an acrylic component. For example, in the secondary battery 100 according to one or more embodiments of the present disclosure, the film layer 131 may chemically react with the electrolyte to be at least partially melted and/or to form pores, over time.

FIG. 3 is a schematic image showing that an electrolyte solution is applied to the finishing tape 130 according to one or more embodiments of the present disclosure, and a glass plate is then placed thereon and pressed. Tests were conducted in three cases. The finishing tapes 130 were formed to have thicknesses of 28 μm, 18 μm, and 15 μm sequentially or respectively in that order from the left, and then tested. However, the thickness of the adhesive layer 132 was set to be the same for all at 3 μm, and only the thickness of the film layer 131 was set differently to 25 μm, 15 μm, and 12 μm, respectively. The width of the finishing tape 130 was 15 mm.

FIG. 4 is a schematic image showing that the glass plate shown in FIG. 3 is left undisturbed at room temperature for one day, and FIG. 5 is a schematic image showing the glass plate of FIG. 4 pushed upward. First, referring to FIG. 4, in all three cases, visually, the shape of the finishing tape 130 seemed to be maintained as it is.

However, referring to FIG. 5, when the thickness of the finishing tape 130 was 18 μm or 15 μm, it was confirmed that when the glass plate is pushed upward, the film layer 131 is almost completely melted and pushed together with the glass plate. In one or more embodiments, when the thickness of the finishing tape 130 was 28 μm, the film layer 131 was not completely melted, but the portions located at the edge of the glass plate were easily broken even when the glass plate was moved slightly.

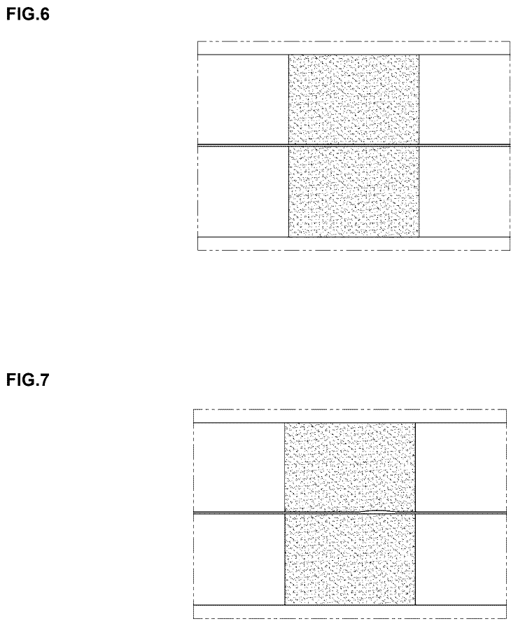

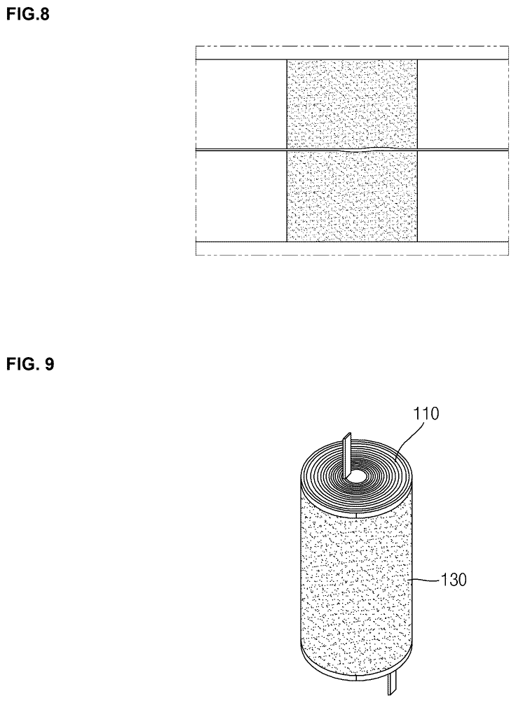

FIGS. 6 to 8 are each a schematic image observed after a certain period of time has elapsed after a finishing tape 130 is attached to an electrode assembly 110, according to one or more embodiments of the present disclosure, and impregnated with an electrolyte solution. Here, tests were also conducted in three cases. The finishing tapes 130 were formed to have thicknesses of 28 μm, 18 μm, and 15 μm sequentially in that order from FIG. 6, and then tested. However, the thickness of the adhesive layer 132 was set to be the same for all at 3 μm, and only the thickness of the film layer 131 was set differently to 25 μm, 15 μm, and 12 μm, respectively. The width of the finishing tape 130 was 15 mm. Referring to FIGS. 6 to 8, in all three cases, as the electrode assembly 110 expands in the radial direction, the nylon tissue was decomposed even with a small force by which the end of a negative electrode plate is slightly opened, and was immediately torn when being touched by tweezers.

From the results of the above-described tests, it is confirmed that, because the adhesive layer 132 is formed of a nylon material, the adhesive layer 132 chemically reacts with an electrolyte to be at least partially melted and/or to form pores, over time.

Related art finishing tapes are often made of PP, PET, OPS, etc., but these materials do not dissolve well because they do not chemically react with electrolytes. When an electrode assembly absorbs an electrolyte, the electrode assembly may expand in the radial direction over time. However, related finishing tapes do not readily expand accordingly, and when the finishing tape is made of OPS, it may even shrink, and thus stress may be generated in the area where the finishing tape surrounds (or is around) the electrode assembly. Accordingly, the electrode assembly may be unintentionally deformed or cracks may occur in the electrode assembly or the finishing tape, which is problematic.

However, in the secondary battery 100 according to one or more embodiments of the present disclosure, the adhesive layer 132 is formed of a nylon material and chemically reacts with the electrolyte to be at least partially melted and/or to form pores, over time, thereby allowing the electrode assembly 110 to expand without restraint when the electrode assembly 110 expands in the radial direction. For example, the adhesive layer 132 is deformed together with the electrode assembly, thereby solving the aforementioned problem.

In one or more embodiments, the finishing tape 130 is for fixing the electrode assembly 110 so that the electrode assembly 110 is not unwound in the process of inserting the electrode assembly 110 into the can 120 in assembling the secondary battery 100, and once the electrode assembly 110 is inserted into the can 120, the role of the finishing tape 130 is finished, and thus any special problems are not caused even when the finishing tape 130 disassembles or falls off.

Furthermore, due to the characteristics of material, in general, it is difficult to manufacture a finishing tape as thin as 16 μm or less for PET and 25 μm or less for OPS, whereas a finishing tape made of nylon can be manufactured as thin as 13 μm or less. Therefore, as the thickness of the finishing tape 130 is reduced, the volume of the electrode assembly 110 relative to the same volume of the can 120 can be increased, thereby contributing to the improvement of battery capacity.

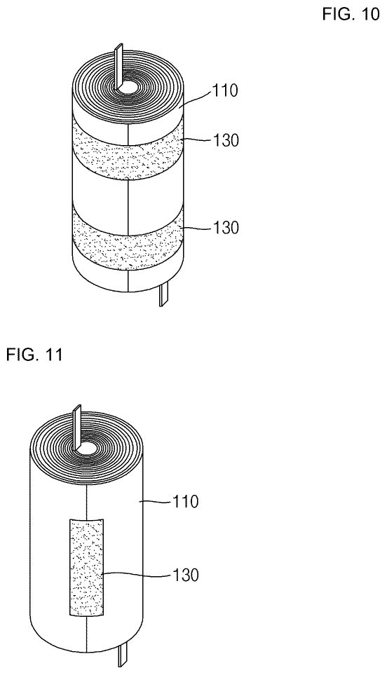

The finishing tape 130 may be formed to have a width smaller than the length of the electrode assembly 110, as illustrated, for example, in FIG. 1. In one or more embodiments, the finishing tape 130 may be formed to have a width corresponding to the length of the electrode assembly 110, as illustrated, for example, in FIG. 9. As illustrated in FIG. 10, a plurality of finishing tapes may be provided and arranged to be spaced apart from one another, and, as illustrated in FIG. 11, the finishing tape 130 may also be attached only to a portion corresponding to the end of winding, instead of around (e.g., surrounding) the electrode assembly 110 as a whole.

The cap assembly 140 serves to seal one surface of the can 120. In one or more embodiments, as shown for example in FIG. 1, the cap assembly 140 includes a cap-up 141 that protrudes convexly so as to be electrically connected to an external circuit and has a hole for discharging gas to the periphery thereof, a safety vent 142 for releasing the pressure by being automatically broken by pressure when the internal pressure of the can 120 increases due to the gas generated inside the can 120, and a cap-down 143 that is installed under the safety vent 142 and is electrically connected to the second electrode plate of the electrode assembly 110.

As described above, in one or more embodiments of the present disclosure, the finishing tape is formed of a nylon material and thus chemically reacts with an electrolyte to be at least partially melt and/or to form pores over time, thereby allowing the electrode assembly to expand without restraint when the electrode assembly expands. For example, by being deformed together with the electrode assembly, the electrode assembly can be prevented or substantially prevented from being unintentionally deformed or cracks can be prevented or substantially prevented from being generated in the electrode assembly or the finishing tape.

In one or more embodiments, the finishing tape can be manufactured relatively thinly due to the characteristics of material, and according as the thickness of the finishing tape is reduced, the volume of the electrode assembly can be increased relative to the same volume of the can, thereby contributing to the improvement of battery capacity.

The vehicle, the electronic device, and/or the battery, e.g., a battery controller, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

While the foregoing embodiments have been provided for carrying out the secondary battery of the present disclosure, which is not limited to these embodiments, it will be understood by a person skilled in the art that one or more suitable changes in form and details may be made herein without departing from the spirit and scope of the present disclosure as defined by the following claims and equivalents thereof.

What is claimed is:

1. An electrode assembly comprising:
a first electrode plate;
a second electrode plate;
a separator between the first electrode plate and the second electrode plate;
wherein the first electrode plate, the second electrode plate, and the separator are wound around an axis to form a wound unit; and
a finishing tape comprising:
a film layer comprising a nylon material, and
an adhesive layer attaching the film layer to the wound unit.

2. The electrode assembly of claim 1, wherein the film layer is to chemically react with an electrolyte:
to be at least partially melted; and/or
to form pores.

3. The electrode assembly of claim 1, wherein the film layer is to chemically react with an electrolyte and to deform to allow the wound unit to expand.

4. The electrode assembly of claim 1, wherein the film layer has a thickness of 12 μm to 25 μm.

5. The electrode assembly of claim 1, wherein the adhesive layer comprises an acrylic component.

6. The electrode assembly of claim 1, wherein the adhesive layer has a thickness of 3 μm or less.

7. The electrode assembly of claim 2, wherein the electrolyte comprises an organic solvent and a lithium salt.

8. The electrode assembly of claim 7, wherein the organic solvent comprises at least one of ethylene carbonate (EC), propylene carbonate (PC), diethyl carbonate (DEC), dimethyl carbonate (DMC), or ethyl methyl carbonate (EMC).

9. The electrode assembly of claim 7, wherein the lithium salt comprises at least one of LiPF₆ or LiBF₄.

10. The electrode assembly of claim 1, wherein the finishing tape is at least partially around the wound unit.

11. The electrode assembly of claim 1, wherein the finishing tape has a length along an outer surface of the wound unit that is smaller than the outer surface of the wound unit.

12. The electrode assembly of claim 1, wherein the finishing tape has a length along an outer surface of the wound unit that corresponds to a length of the outer surface of the wound unit.

13. The electrode assembly of claim 1, wherein the finishing tape comprises a plurality of finishing tapes spaced apart from one another.

14. The electrode assembly of claim 1, wherein the finishing tape is partially around the wound unit and attached to an end of the wound unit along a winding direction.

15. The electrode assembly of claim 1, wherein the finishing tape surrounds the wound unit in a winding direction.
